(19) United States
(12) Patent Application Publication
(10) Pub. No.: US 2016/0146329 A1
(43) Pub. Date: May 26, 2016

(54) DRIVE TRAIN AND ADAPTER DEVICE

(71) Applicant: SIEMENS AKTIENGESELLSCHAFT, Munchen (DE)

(72) Inventor: WOLFGANG SCHNURR, NEHREN (DE)

(73) Assignee: SIEMENS AKTIENGESELLSCHAFT, Munchen (DE)

(21) Appl. No.: 14/949,329

(22) Filed: Nov. 23, 2015

(30) Foreign Application Priority Data
Nov. 24, 2014 (EP) 14194537

(51) Int. Cl. F16H 57/025; F16H 57/04

(52) U.S. Cl. CPC F16H 57/025; F16H 57/0412; F16H 2057/02034

(57) ABSTRACT

A drive train includes a motor having a motor housing and a motor shaft, and a gear unit having a gear unit housing and a driveshaft, with a coupling device connecting the motor shaft and the driveshaft to one another. An adapter device is disposed between the motor and the gear unit and has an adapter housing which is detachably connected to the motor housing and the gear unit housing. At least one cooling cartridge is fastened to the adapter housing and provided to cool oil within the gear unit housing during operation of the drive train.

### CROSS-REFERENCES TO RELATED APPLICATIONS

This application claims the priority of European Patent Application, Serial No. 14194537.8, filed Nov. 24, 2014, pursuant to 35 U.S.C. 119(a)-(d), the disclosure of which is incorporated herein by reference in its entirety as if fully set forth herein.

### BACKGROUND OF THE INVENTION

The present invention relates to a drive train. The present invention also relates to an adapter device for connecting a motor shaft and a driveshaft of a gear unit.

The following discussion of related art is provided to assist the reader in understanding the advantages of the invention, and is not to be construed as an admission that this related art is prior art to this invention.

Drive trains and adapter devices of the type described above are known in various embodiments. Adapter devices are used to pair a predetermined motor with a predetermined gear unit. Using a plurality of such adapter devices, drive train series can be realized in which an individual motor can be connected to a number of gear units and/or an individual gear unit can be connected to a number of motors. Furthermore, so-called cooling cartridges are known for dissipation of heat, caused in particular as a result of friction and churning losses from the gear unit. For example MOTOX gear units from Siemens AG are equipped with cooling cartridges connected to a cooling water supply. The cooling cartridges are installed via a gear unit installation cover, which is normally disposed upstream of the slow-running gear unit stages of the gear unit.

It would therefore be desirable and advantageous to provide an improved drive train and an improved adapter device to obviate prior art shortcomings.

### SUMMARY OF THE INVENTION

According to one aspect of the present invention, a. drive train includes a motor having a motor housing and a motor shaft, a gear unit having a gear unit housing and a driveshaft, an adapter device disposed between the motor and the gear unit, the adapter device having an adapter housing which is detachably connected to the motor housing and the gear unit housing, and a coupling device which connects the motor shaft and the driveshaft to one another, and at least one cooling cartridge fastened to the adapter housing and provided to cool oil within the gear unit housing during operation of the drive train.

Use of a cooling cartridge that is fastened to an adapter housing is advantageous because of the presence of sufficient installation space in the area of the adapter housing, so that the cooling cartridge can be easily accommodated constructively. Also, existing drive trains can easily be retrofitted with such a cooling cartridge. When the gear unit involved is a reduction gear unit, the arrangement of the cooling cartridge on the adapter housing is also of advantage because the cooling cartridge is automatically positioned in the area of the fast-running input stage of the gear unit, so that the cooling cartridge, because of the more intense movement of oil, can operate with at a very good level of efficiency. The cooling cartridge can be disposed such that it is immersed directly in the oil sump present in the lower area of the gear unit housing. As an alternative, the cooling cartridge may also be disposed so as to cool the spray oil or the oil mist.

According to another advantageous feature of the present invention, the adapter housing can be flange-mounted onto the motor housing and onto the gear unit housing. In this way, a stable structure of the drive train is guaranteed.

According to another advantageous feature of the present invention, the cooling cartridge can be fastened detachably to the adapter housing. As a result, the cartridge can easily be replaced or serviced.

According to another advantageous feature of the present invention, the cooling cartridge has an outer thread, which can be threadably engaged into a threaded bore of the adapter housing. This results in an overall simple construction.

According to another advantageous feature of the present invention, at least one threaded plug may be provided for threadably engaging into the threaded bore, when the cooling cartridge is removed. In this way, there is the option to realize a drive train with and without cooling cartridge. As an alternative, the cooling cartridge can also be connected to the process cooling of the facility.

According to another advantageous feature of the present invention, the drive train can be constructed as a part of a gear unit series, having different motors, different gear units and different adapter devices for selectively connecting the motors and gear units.

According to another advantageous feature of the present invention, the cooling cartridge can be fastened to a wall of the adapter housing, with the coupling device sized to extend through the wall. As the wall is easily accessible, the cooling cartridge can thus be easily installed and removed. In addition, the cooling cartridge can have a simple rod-shaped structure.

According to another advantageous feature of the present invention, the cooling cartridge can be connected to a coolant supply of the- motor. Since the motor is disposed immediately adjacent to the adapter device, such a connection of the cooling cartridge to the coolant supply of the motor can be realized in a simple manner with little outlay in material.

According to another aspect of the present invention, an adapter device includes an adapter housing, a coupling device configured to connect a motor shaft and a driveshaft of a gear unit, and at least one cooling cartridge fastened to the adapter housing and provided to cool an oil sump of the gear unit, when the adapter device is installed.

According to another advantageous feature of the present invention, the cooling cartridge can be fastened detachably to the adapter housing. Advantageously, the cooling cartridge can have an outer thread which can be threadably engaged into a threaded bore of the adapter housing.

According to another advantageous feature of the present invention, the cooling cartridge can be fastened to a wall of the adapter housing, with the coupling device sized to extend through the wall.

According to another advantageous feature of the present invention, the adapter housing can have a coolant feed line and a coolant discharge line which can both be sized to extend through a housing wall of the adapter housing. The position of the coolant feed line and coolant discharge line can be selected such that the lines become easily accessible.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic perspective view of a drive train according to the present invention;

FIG. 2 shows a schematic perspective view of a motor and an adapter device of the drive train shown in FIG. 1; and

FIG. 3 shows a schematic perspective view of an adapter device of the drive train shown in FIG. 1, when the adapter device is viewed from a side of the motor in a direction of the gear unit.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

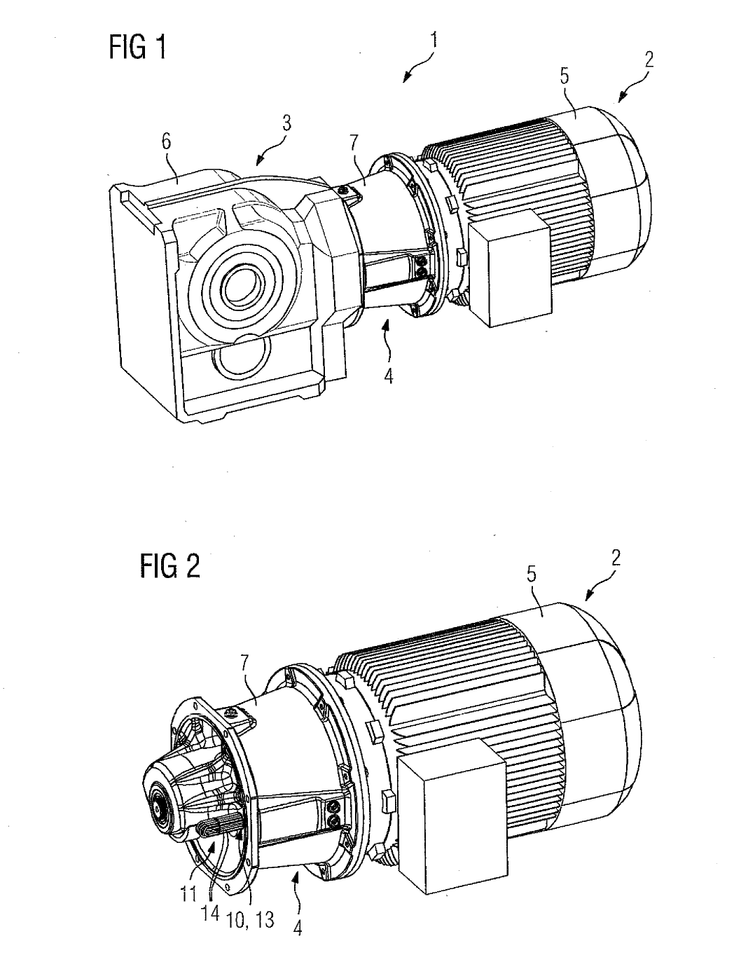

Turning now to the drawing, and in particular to FIG. 1, there is shown a drive train according to the present invention, generally designated by reference numeral 1 and including has a motor 2, a gear unit 3 and an adapter device 4 as its main components. The drive train 1 can form part of a gear unit series, having a number of different motors, gear units and adapter devices, which can be paired with one another to the need at hand. The motor 2 serves as drive unit and includes a motor housing 5 and a motor shaft not shown in any greater detail. The gear unit 3 involves a reduction gear unit with a gear unit housing 6 and includes a driveshaft and an output shaft, which are not shown for sake of simplicity.

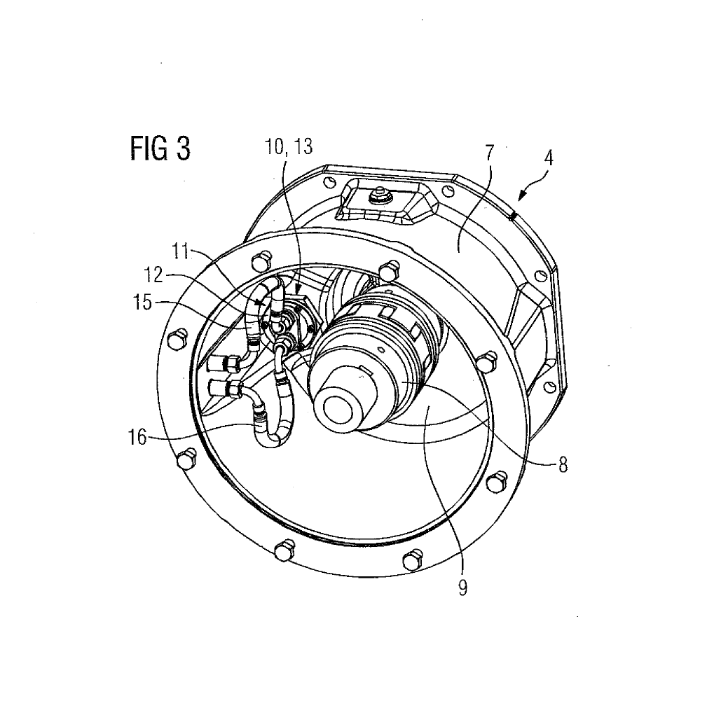

The adapter device 4 is disposed between the motor 2 and the gear unit 3 and includes an adapter housing 7 which is flange-mounted onto the motor housing 5 and onto the gear unit housing 6. A coupling device 8 connects the motor shaft to the driveshaft of the gear unit 3 and extends through the adapter housing 7. As readily apparent from FIG. 3, the coupling device 8 extends through a wall 9 of the adapter device 4. The wall 9 defines hereby a partition wall between the motor 2 and the gear unit 3 and has a threaded bore 10 in an off-center position.

To discharge heat generated in the gear unit 3 during operation of the drive train 1, in particular as a result of friction and churning losses, a cooling cartridge 11 is provided. The cooling cartridge 11 includes a cooling cartridge head 12, having an outer thread 13 and coolant connections not shown in greater detail. The coolant connections are fluidly connected to coolant lines 14 of essentially U shape, as shown in FIG. 2. The coolant lines 14 extend outwards from the cooling cartridge head 12. The cooling cartridge 11 is introduced from the side of the motor 2 through the threaded bore 10 provided in the wall 9 of the adapter device 4 and is threadably engaged to the adapter device 4. Thus, the coolant lines 14 project outwards in the direction of the gear unit 3. The position of the threaded bore 10 is hereby selected such that the coolant lines 14 are immersed completely in the oil sump of the gear unit 3 during operation of the drive train 1. As an alternative, the cooling cartridge 11 can also be disposed further upwards, so that it cools the spray oil or the oil mist. The coolant connections of the cooling cartridge 11 are connected to a coolant feed line 15 and a coolant discharge line 16, which extend through the adapter housing 7 and are connected to a coolant supply of the motor 2, not shown in greater detail.

During operation of the drive train 1, coolant, for example cooling water, is conducted through the coolant lines 14 of the cooling cartridge 11. Heat from oil of the gear unit 3 is drawn by the coolant and discharged. As a result of the direct heat transfer of heat from oil to the cooling cartridge, an optimal gear unit cooling is achieved. The cooling power of the cooling cartridge 11 can be set by the temperature of the supplied coolant and by the volume flow of the coolant. In the event, the cooling power of a single cooling cartridge 11 is inadequate, any number of cooling cartridges 11, of course, can be provided that best suits the needed cooling power at hand. of.

When, no cooling action is required, for example a situation in which free convection is sufficient for cooling the gear unit 3, a threaded plug (not shown) can be inserted in the threaded bore 10 of the wall 9 in the adapter housing 7, instead of a cooling cartridge 11.

The provision of the cooling cartridge 11 is able to reduce ageing of the oil so that the time period between oil changes can be extended. A significant advantage of the construction of the drive train 1, as described above, is the fact that the cooling cartridge 11 is fastened to the adapter housing 7 of the adapter device 4 and thus at a position where sufficient installation space is available. Thus, the cooling cartridge 11 can be installed in a constructively simple manner. Furthermore, existing adapter devices which have not previously been provided with a cooling cartridge can easily be upgraded and retrofitted. Advantageously, the cooling cartridge 11 is automatically positioned in the area of the fast-running input stage, so that the cooling cartridge 11 can be operated at a very high level of efficiency. In addition, cooling primarily takes place in the fast-running area of the gear unit 3, so that the service life of a seal of the input shaft of the gear unit is significantly increased, since both temperature and high speed contribute to ageing of a sealing ring.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A drive train, comprising:
a motor having a motor housing and a motor shaft;
a gear unit having a gear unit housing and a driveshaft;
an adapter device disposed between the motor and the gear unit, said adapter device having an adapter housing which is detachably connected to the motor housing and the gear unit housing, and a coupling device which connects the motor shaft and the driveshaft to one another; and
at least one cooling cartridge fastened to the adapter housing and provided to cool oil within the gear unit housing during operation of the drive train.

2. The drive train of claim 1, wherein the adapter housing is flange-mounted onto the motor housing and onto the gear unit housing.

3. The drive train of claim 1, wherein the cooling cartridge is fastened detachably to the adapter housing.

4. The drive train of claim 1, wherein the cooling cartridge has an outer thread, which is threadably engaged into a threaded bore of the adapter housing.

5. The drive train of claim 4, further comprising at least one threaded plug configured for threadably engaging into the threaded bore, when the cooling cartridge is removed.

6. The drive train of claim 1, wherein the cooling cartridge is fastened to a wall of the adapter housing, said coupling device sized to extend through the wall.

7. The drive train of claim 1, wherein the cooling cartridge is connected to a coolant supply of the motor.

8. The drive train of claim 1, constructed as a part of a gear unit series, having different motors, different gear units and different adapter devices for selectively connecting the motors and gear units.

9. An adapter device, comprising:
an adapter housing;
a coupling device configured to connect a motor shaft and a driveshaft of a gear unit; and
at least one cooling cartridge fastened to the adapter housing and provided to cool an oil sump of the gear unit, when the adapter device is installed.

10. The adapter device of claim 9, wherein the cooling cartridge is fastened detachably to the adapter housing.

11. The adapter device of claim 9, wherein the cooling cartridge has an outer thread threadably engaged into a threaded bore of the adapter housing.

12. The adapter device of claim 9, wherein the cooling cartridge is fastened to a wall of the adapter housing, said coupling device sized to extend through the wall.

13. The adapter device of claim 9, wherein the adapter housing has a coolant feed line and a coolant discharge line which are both sized to extend through a housing wall of the adapter housing.
